(19) United States
(12) Patent Application Publication
(10) Pub. No.: US 2005/0189338 A1
(43) Pub. Date: Sep. 1, 2005

(54) Heat apparatus for extending the life of blade cutting edges

(76) Inventor: Carl James Sukeforth, Lexington, MA (US)

Correspondence Address: CARL JAMES SUKEFORTH, 5 GOODWIN ROAD, LEXINGTON, MA, 02420, US

(21) Appl. No.: 10/787,039

(22) Filed: Feb. 26, 2004

(51) Int. Cl. H05B 3/20

(52) U.S. Cl. 219/228

(57) ABSTRACT

A method and apparatus for extending the useful life of blade cutting edges, especially shaving razors, comprising a unit having a configuration to support and store the blade or razor and a heat source to raise the temperature of the blade or razor and eliminate contact water through evaporation and further inhibit condensation by maintaining the proximate water vapor above its saturation temperature. Inhibiting the formation of iron oxide and hydrated iron oxide (Rust) extends the life of the blade.

### BACKGROUND OF INVENTION

Cutting edges work by concentration of force. The smaller an area a given force works upon, the higher the pressure applied and the better the cutting capacity. Maintenance of a sharp edge is crucial to the effectiveness of a cutting blade. Anything that reduces blade sharpness reduces this effectiveness. One mechanism that reduces a blade's sharpness is corrosion. For steel blades, corrosion is often the result of oxidation. Iron corrodes in the presence of oxygen and water. This corrosion of iron is an electrochemical process. In a water droplet contacting the blade, dissolved oxygen at the edge of the droplet and close to the metal tends to react with free electrons from the metal, oxidizing iron atoms, Fe, to Fe²⁺. The electrons lost by these atoms are replaced by other free electrons from iron atoms within the conducting metal, preferentially from beneath the droplet. When these atoms give up electrons, they also form Fe²⁺ and can migrate into the contact water, where they react with more oxygen and are oxidized further into Fe³⁺. Fe³⁺ then precipitates out as hydrated iron oxide (rust), which builds up on the surface of the metal. Sharp edges accumulate free electrons and are therefore areas of high corrosive activity. The process accelerates as the water becomes more conductive due to increasing dissolved metal ions and if left unchecked, eventually form pits in the cutting edge and dull it. It's this type of corrosion that this invention was designed to reduce and therefore extend the useful life of a cutting edge. Blades can also corrode due to salt attack. Water moves through the earth dissolving minerals, holding them in solution as salts, consisting mainly of calcium and magnesium. The concentration of such dissolved salts is defined as the hardness of the water. Tap water sources vary in hardness. These salts can build up on the surface of a blade over repeated exposure to tap water. Such build up itself can reduce the effectiveness of a cutting edge as well as produce dulling corrosion. Another claim of this application is to reduce the effects of this type of build-up and its subsequent chemical corrosion.

Several patents have been granted for devices extending of the useful life of cutting blades.

U.S. Pat. No. 3,516,209, granted to Virtanen, uses a finger-held device to strop a cutting blade, requiring a sliding action to sharpen the cutting edge. This invention does not prevent corrosion due to exposure in a humid environment and is inefficient.

U.S. Pat. No. 3,736,243, granted to Duggan, uses stored electrical energy in the form of a battery to create a flow of electrons over the conducting surface of the blade to stop electrochemical corrosion of the blade. This invention is expensive due to required replacement of DC batteries.

U.S. Pat. No. 4,027,387, granted to Kellis, cleans the debris from a razor after use by means of flowing water. The unit is complex and does not address dullness due to corrosion.

U.S. Pat. No. 4,642,893, granted to Borenstein, uses a refrigerant to thermally contract a blade and thereby reduce the dimension of any irregularities creating dullness. The refrigerant is a costly consumable item. The unit is impractical and does not address dullness due to corrosion.

U.S. Pat. Nos. 5,329,699 and 5,638,042 granted to McCoy, use magnetic lines of force to form a protective magnetic field barrier to stop electrochemical corrosion to a cutting blade. Such devices require optimized configurations that would not easily accommodate blades of differing sizes and is expensive due the required magnets.

Most of the above inventions have consumable parts or parts that wear through use. All of the above devices are complex and expensive compared to the simplicity of the claimed invention.

References: Title: Introduction to Heat Transfer, Authors: Incropera and Dewitt, Publisher: John Wiley and Sons, pp. 1-12, 516-520. Title: General Chemistry, Authors: Atkins and Beran, Publisher: Scientific American, pp. 374, 674-676. Title: Terminology G15-99b Standard Terminology Relating to Corrosion and Corrosion Testing Copyright 2001 AMERICAN SOCIETY FOR TESTING AND MATERIALS, West Conshohocken, Pa.

### SUMMARY OF INVENTION

The inventor has devised a simple, inexpensive device for extending the life of a cutting edge, especially razor blades. Inhibiting the corrosion that occurs when a blade is exposed to water and oxygen increases the useful life of the blade. After a blade or razor is exposed to water, it is placed and stored within the device and the device heats the blade, raising its temperature, and eliminates any contact water through the mechanism of evaporation. The device also continuously heats the proximate water vapor around the blade, which raises its saturation temperature and inhibits condensation of water onto the blade that could lead to corrosion. It is an object of this invention to provide a simple inexpensive corrosion inhibiting apparatus to extend the life of a cutting blade, comprising an assembly of structural units consisting of a housing with
a. a configuration to support a blade or razor
b. an integrated electric heater
c. an electric plug for engagement with a standard household electrical outlet

### BRIEF DESCRIPTION OF DRAWINGS

FIG. 1 is a perspective view of the preferred embodiments of the invention.

FIG. 2 is a perspective back view of the preferred embodiments of the invention.

FIG. 3 is an exploded view of the preferred embodiments of the invention.

FIG. 4 is a perspective view of the preferred embodiments of the invention cradling a representative conventional razor.

### DETAILED DESCRIPTION

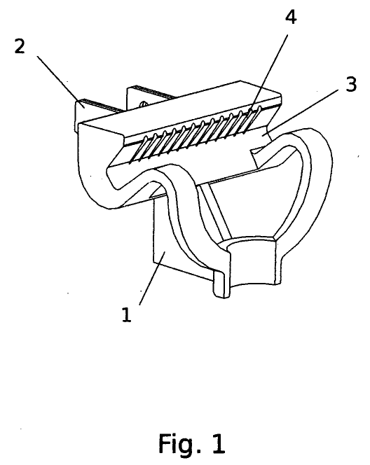

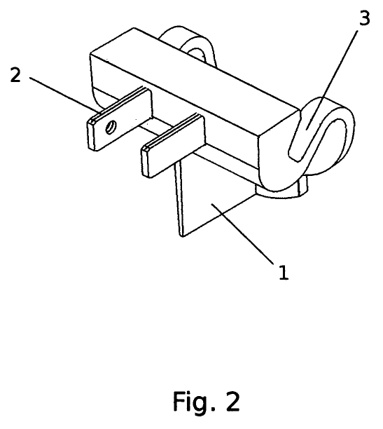

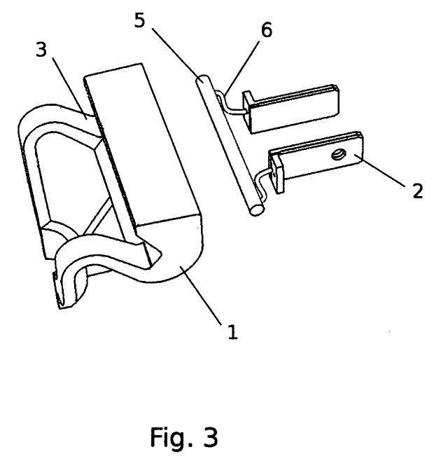

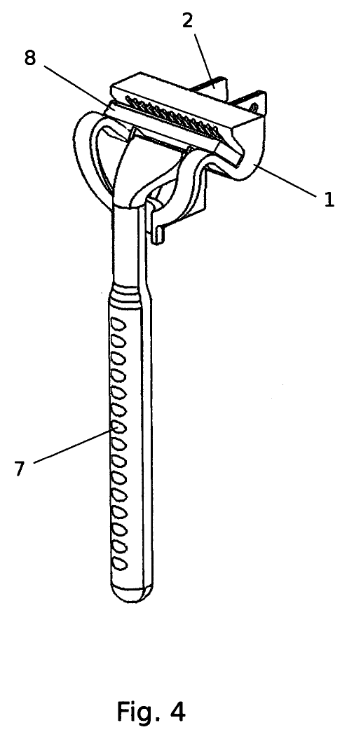

FIGS. 1 through 4 identify the preferred embodiments of the device and designate the device elements (1-8). In assembled form, the injection molded device housing, element (1), has a cradle, element (3) to hold a razor, element (7), FIG. 4. The device plugs into a standard 120VAC electrical wall outlet by means of twin metal prongs, elements (2), which connect to an electrical resistance-heating component, element (5) via electrical leads, elements (6), FIG. 3. The heat energy generated by this heating circuit raises the temperature of the housing in the area above the cradle, element (3), in vicinity to grooves, elements (4). The heat energy transfers to the blades in a razor's head, element (8), FIG. 4, by means of conduction, convection and radiation.

After use, water is present on the blades of a razor. Corrosion of the blades occurs with the presence of contact water and contributes to dulling of the blades. Raising the temperature of the contact water increases the water's vapor pressure. The evaporation rate of a liquid increases as its vapor pressure increases. As evaporation transpires, the water vapor molecules above the liquid water accumulate and leave less room for further vapor molecules. This has a depressing effect on the evaporation rate. Reducing the concentration of these vapor molecules at the surface increases the rate of evaporation. In this device, the grooves, elements (4), FIG. 1 allow convective forces to create air flow across the face of the razor blades, which drives the proximate water vapor molecules away from the contact water, facilitating further evaporation. This active drying of the blades inhibits corrosion caused by water contact and therefore extends the blades useful life.

Between uses, razors are often exposed to humid environments. Storage of a razor in the device between uses would continuously heat the proximate water vapor around the blade and thereby maintain an increased vapor saturation temperature inhibiting condensation of water onto the blade that could lead to corrosion.

Having now described and shown particular preferred embodiments of the invention, various alternate modifications may be apparent to those skilled in the art and therefore is not intended that the invention be limited to the details thereof and departures may be made there from within the spirit and scope of the claims.

1. An electric apparatus in conjunction with blade cutting edges, such as shaving razors, said device comprising;
a housing with an integrated electrical resistance heating element
a cradle in said housing with a configuration to hold a cutting blade or razor in proximity to said heating elements by means of magnetic or gravitational force.
a configuration that allows for heating of the blade by means of combination of conduction, convection and radiation or by induction.

2. A method for inhibiting corrosion of a cutting blade by placing said blade in close proximity a heat source to raise the temperature of the blade and eliminate contact water through evaporation and thereby inhibiting the formation of iron oxide and hydrated iron oxide, rust, and further inhibit corrosion during storage of blade by inhibiting condensation of water onto the blade by continuously heating and maintaining the proximate water vapor above its saturation temperature.

3. The method of claim 2, wherein the addition of a desiccant, such as calcium oxide or silica gel is used to enhance the reduction of water vapor in proximity of the cutting blades.

4. The method of claim 2, wherein the blade is rinsed in Dl water prior to being place in the heating apparatus in order to inhibit build-up of salts deposits and possible subsequent salt corrosion due to use of hard tap water.
